(19) United States
(12) Patent Application Publication
(10) Pub. No.: US 2010/0091202 A1
(43) Pub. Date: Apr. 15, 2010

(54) Glass Fibre Reinforced Plastic Substrate

(76) Inventor: Toni P. Östergård, Turku (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 12/308,813

(22) PCT Filed: Jun. 22, 2006
(86) PCT No.: PCT/FI2006/000226

§ 371 Date: Sep. 25, 2009

(51) Int. Cl. G02F 1/1335; B32B 17/04; B27N 3/04; B27N 3/08; C08K 3/40; G02F 1/1333

(52) U.S. Cl. 349/11; 428/426; 264/109; 264/121; 264/112; 524/599; 349/158

(57) ABSTRACT

A glass fibre reinforced plastic substrate provides the mechanical strength and thermal properties for use e.g. in flat display devices. There is a trend towards flat display devices comprising flexible displays. Such display devices also need flexible substrates, and a method to produce such flexible substrates cost effectively. To make such flexible display by conventional manufacturing technologies that have been applied to produce the LCD displays, glass substrates need to be replaced with elastic substrate materials that are deformable even at room temperatures. The elastic substrate must have mechanical durability to offer flexibility desired. Now there is developed a method for producing a glass fibre reinforced plastic substrate so that the glass fibres and binding material are arranged to form a layer with a certain content of glass fibres and then the layer is arranged to be pressed to a thickness that is desirable to the substrate sheet.

### TECHNICAL FIELD OF THE INVENTION

This invention relates to a substrate for use in a flat display device, and more particularly to a flexible substrate in which glass fibre reinforced plastic provides the mechanical strength and thermal properties for use in the flat display device. This invention further relates to a flat display device comprising such flexible substrate, and a method for producing such flexible substrate.

### BACKGROUND OF THE INVENTION

A liquid crystal display (LCD) technology is today one of the most commonly used display technologies in computer monitors and in monitors for portable electronics, e.g. portable information devices or the like. These flat display devices are most popular in mobile telecommunication devices, laptops, personal computers and television sets, etc. LCDs are advantageous in that they are thin and consume relative little power. In LCDs, liquid crystal is typically sealed between a pair of substrates each having an electrode formed thereon. The orientation of the liquid crystal disposed between these electrodes is controlled by these electrodes in order to achieve display.

An example of such display technologies is an active-matrix (AM) LCD which is a thin and lightweight display device that realizes a high resolution with reduced power dissipation. A plurality of pixels are provided in a matrix within the display area. A silicon (Si) transistor structure is typically used to drive a plurality of pixels on the AM LCD display in which a switching element such as the Si transistor is provided for each pixel. Such transistor structures may be based on e.g. amorphous silicon (a-Si), low temperature polysilicon (LTPS) and continuous grain silicon (CGS) technologies. There are also other well known display technologies that may use the same AM technology.

A crucial point of the AM LCD technology is high manufacturing costs of active matrix (AM) backplanes which consist of a substrate with transistor structures and conducting lines. To reduce size and weight of flat display devices there is a trend to replace the conventional glass substrate of displays with a plastic substrate. However, processing parameters related to formation Si transistors onto the substrate, i.e. processing of the deposited Si thin film and thin film transistor (TFT) structures, is not optimal for plastic based substrates. It is possible to manufacture AM backplanes onto plastic substrates, but the manufacturing process is very challenging and therefore additional costs are expected.

There is also a trend to produce flat displays that can be folded or rolled. A variety of these flexible display devices ranges from conformable and bendable displays to fully flexible displays. Glass is obviously too brittle material for flexible displays because it will easily break if it is made thin enough to be flexible. To make such a flexible display by conventional manufacturing technologies that have been applied to produce the LCD or electroluminescence (EL) displays, glass substrates need to be replaced with elastic substrate materials that are deformable even at room temperatures. Such materials, e.g. plastic and stainless steel, have the right mechanical durability but they do not have the low coefficient of thermal expansion (CTE) of glass. When exposed to heat, the plastic or stainless steel substrate is easily deformed or warped. Plastic materials also poorly resist the heat. Further, the plastic material poorly resist the humidity and/or other chemicals that may be absorbed into the substrate, affecting the dimensions of the substrate.

So, there are still a number of obstacles that must be overcome in order to use a plastic substrate as a substrate for a flat display effectively. The plastic substrate has the high coefficient of linear thermal expansion which means that it is difficult to align electronic components with high precision onto such an easily expandable substrate when increasing temperature. The processing parameters related to the formation of silicon transistors onto the substrate are not optimal for plastic based substrates. Therefore, the manufacturing process for display technologies using plastic substrates is very challenging and therefore coupled with additional costs does not make it a very competitive technology.

The plastic substrates require much lower processing temperatures, and the dimensional changes during various processing temperatures make it difficult to align the various processes used in the manufacturing stage. Stainless steel has been tested and found to be suitable for some applications, but so far optimal substrate has not been found.

To make the size of the plastic substrate more stable by reducing the coefficient of linear thermal expansion, it is possible to use substrate structures made of composite materials and plastic substrates. As an example of prior art, a composite material is made of filling a layer of glass fiber fabric (or mat) with a resin on top of the plastic substrate. In prior art, the layer of the resin with fibers is then cured on the surface of the plastic substrate to form a glass fiber mat on top of the substrate. It is typical that the plastic substrate includes a composite surface layer that is formed by arranging linear or striped fibers in a resin so that the plurality of fibers are in due order. In prior art the orientation of individual fibers is precisely defined in order to increase the mechanical strength of the composite layer, and the fibers are preferably aligned uniformly all over the plane. If the fiber bundles are aligned in two perpendicular directions within the composite layer then the composite layer forms a plane woven fabric on the surface of the plastic substrate in prior art solutions.

However, such glass fiber reinforced substrates of prior art are made of plastic substrates having on top a layer of composite material including glass fiber and resin. This composite layer is used as a glass fiber mat on the surface of the plastic substrate. This arrangement improves mechanical durability and thermal stability of the plastic substrate. But still the manufacturing process is rather complicated and therefore expensive, because it requires firstly to produce the glass fiber reinforced mat by assembling glass fiber fabric with the resin to form the mat and curing the mat, and secondly to fasten the mat made of glass fiber and resin on the surface of the plastic substrate.

The problems set forth above are overcome by providing a new type of substrate for flexible display applications.

### SUMMARY OF THE INVENTION

It is an object of the invention to provide a glass fiber reinforced plastic substrate which is transparent, have thermal stability close to glass and the durability of plastic substrates. These features of the substrate are ideal for flexible display devices. There is also provided a low cost, easy to use and fast manufacturing process of such substrates.

In accordance with a first aspect of the invention the objects are achieved by providing a flexible substrate, which comprises glass fibres and binding material, wherein said glass fibres is arranged to have random orientation.

In accordance with one embodiment of the invention there is provided a substrate, wherein the binding material comprises soft thermoplastic polymer material.

Preferably a polyester having a similar refractive index as glass of the glass fiber is provided.

In accordance with a second embodiment of the invention there is provided a substrate, wherein the binding material comprises soft precursor polymer material.

In accordance with a third embodiment of the invention there is provided a substrate, wherein the binding material comprises soft monomer material that is polymerized or crosslinked.

In accordance with one embodiment of the invention there is provided an apparatus comprising such a flexible substrate.

In accordance with a second aspect of the invention the objects are achieved by providing a flexible display device, which comprises a flexible substrate having glass fibres and binding material, wherein said glass fibres is arranged to have random orientation.

In accordance with a first embodiment of the invention there is provided a flexible display device comprising a flexible substrate, wherein said glass fibers and said binding material is arranged to form a layer, and a relative content of said glass fibers in said layer can be selected.

In accordance with a second embodiment of the invention there is provided a flexible display device comprising a flexible substrate, wherein said layer is arranged to have a thickness of the substrate.

In accordance with a third embodiment of the invention there is provided a flexible display device further comprising a plurality of transistors and a plurality of conducting lines configured to form an integrated flexible electronic module with the flexible substrate, wherein the plurality of conducting lines are arranged to interconnect the plurality of transistors within the flexible electronic module.

In accordance with one embodiment of the invention there is provided an apparatus comprising such a flexible display device.

In accordance with a third aspect of the invention there is provided a method of producing a flexible substrate for a flexible display device, wherein the method comprises steps of supplying glass fibers and binding material to form a layer where glass fibres have random orientation and pressing said layer to a thickness of the substrate.

In one preferred embodiment of the invention the glass fibers and/or binding material are sprayed.

In another preferred embodiment of the invention the step of pressing comprises rolling by at least one roll the layer to the thickness of the substrate.

Preferably, rolling the layer in a form of a sheet to the thickness of the substrate.

In still another preferred embodiment of the invention after rolling the layer in a form of a sheet to the thickness of the substrate, the sheet of layer having the thickness of the substrate is rolled to a collecting reel.

In accordance with one embodiment of the invention the layer comprises the binding material that is soft thermoplastic polymer material, preferably polyester, and has a similar refractive index as glass of the glass fiber.

In accordance with a second embodiment of the invention the layer comprises the binding material that is precursor polymer material.

In accordance with a third embodiment of the invention the layer comprises the binding material that is polymerizable solution of monomer material.

Preferable, the monomer material is polymerized or crosslinked by UV/IR radiation after the step of supplying.

In accordance with one further embodiment of the invention there is provided a method of producing a flexible display device comprising such a flexible display device.

A benefit of the embodied invention provides a solution in which the glass fiber reinforced plastic substrate has better mechanical strength and thermal stability than pure plastic substrate so that the substrate according to the invention is suitable for flexible display devices. Further the substrate according to the invention is suitable for three dimensional displays.

Another benefit of the embodied invention provides a solution in which the glass fiber reinforced plastic substrate is easier to manufacture and faster for volume production than manufacturing of the mat made of glass fiber and resin and fastening the mat on the surface of the plastic substrate.

### BRIEF DESCRIPTION OF THE DRAWINGS

An embodiment of the invention will be described in detail below, by way of example only, with reference to the accompanying drawings, of which

FIG. 1 depicts a block diagram of the method according to the invention, and

FIG. 2 depicts a schematic illustration of the manufacturing process according to the invention,

FIG. 3 depicts a cross-sectional view of the flexible substrate according to the invention,

FIG. 4 depicts an exploded view of a flexible display device according to an embodiment of the invention, and

FIG. 5 depicts an apparatus comprising an embodiment of the flexible display device according to the invention.

### DETAILED DESCRIPTION OF THE INVENTION

An active matrix (AM) backplane has become an important issue today because flexible AM displays are gaining their popularity among future display technology. A substrate of such backplane has an important role. It must be conformable, bendable and flexible and at the same time it has to be mechanically durable enough to support the display. The ideal substrate for the AM backplane would have glass-like transparency, glass-like thermal stability and plastic-like durability. The answer is a glass fiber reinforced flexible plastic substrate. According to the present invention there is provided a substrate made of a mixture of individual glass fibres and binding material (glass fiber-binder blend). The glass fiber content of the mixture is definable according to the needs of the substrate as explained later.

The manufacturing costs of the AM backplanes, i.e. the substrate with the transistor structures and conducting lines, for flat display devices may be relatively expensive. The manufacturing costs are even more expensive if plastic substrates are used, since processing parameters related to the formation of Si transistors onto the plastic based substrates are not optimal. Because of its poor thermal stability the plastic substrate requires much lower processing temperatures than glass substrates having better thermal stability. For the same reason various process temperatures cause dimensional changes to the plastic substrate and therefore it would be difficult to align the various processes used during manufacturing of the AM backplane. The answer is that the substrate of the AM backplane would be manufactured of glass fiber reinforced flexible plastic substrate. According to the present invention there is provided a method of manufacturing a flexible substrate composed of a mixture of individual glass fibres and binding material (glass fiber-binder blend). The glass fiber content of the mixture is definable according to the needs of the substrate as explained later. Preferably, an almost homogeneous mixture of glass fibres and binding material, such as plastic or polymer, is formed. Thickness and surface roughness of the substrate according to the invention is controllable.

The basic idea of the invention is to create a glass fiber reinforced plastic substrate, and more precisely, a mixture of glass fibers and binding material, where the binding material is any suitable soft thermoplastic polymer material, used to create flexible display devices. A refractive index of the thermoplastic polymer should be similar to the refractive index of the glass that is used in the fibers. For example polyester is often used with glass fibers. Other suitable soft thermoplastic polymer materials are e.g. polymethyl methacrylate (PMMA), polycarbonate (PC), polyethylene (PE), polystyrene (PS), etc. The formation of glass fibers as such is well known for those skilled in the art.

An alternative approach is to replace the thermoplastic polymer with a precursor polymer as a binder material. Still another alternative binding material is to replace the thermoplastic polymer with a polymerizable solution of monomers (or similar) that is then crosslinked or polymerized, e.g. by UV or IR radiation, after supplying, e.g. spraying the glass fiber-binder blend.

The content of glass fibers in the substrate according to the invention is selectable and it can be low or high or anything between. The relative content of glass fibers and plastic material (i.e. binding material) in the substrate depend on the required performance of the substrate, and it will be a compromise between certain parameters. If there is a need to increase thermal stability of the glass fiber reinforced plastic substrate according to the invention, the content of glass fibers should be high, from 50 volume % up to 90 volume % or even higher. The higher the content of glass fibers in the substrate, the better the thermal stability of the substrate. If there is a need to increase mechanical durability of the glass fiber reinforced plastic substrate according to the invention, the content of glass fibers should be lower, from 10 volume % to 50 volume % or even less than 10 volume %. The lower the content of glass fibers in the substrate, the better the mechanical durability of the substrate.

However, even with low content of glass fibres in the substrate, the glass fibers constrict the thermal expansion of the substrate and provide better thermal stability than the pure plastic substrate and basically the same mechanical durability as the pure plastic substrate. Respectively, if the relative content of glass fibers is very high, e.g. more than 90 volume %, even the very low content of plastic material in the substrate provides better mechanical durability than pure glass fiber substrate. The reason for this is that even the low content of the plastic binding material hinders the propagation of cracks in the substrate.

A flexible substrate according to the invention is usable in a variety of end products, such as computer monitors, portable electronic devices, laptops, personal computers, television sets, PDAs, radio devices, and head up displays (HUD) for implementations in motorcycle helmets, flight helmets or alike, and virtual reality helmets to be used in computer games.

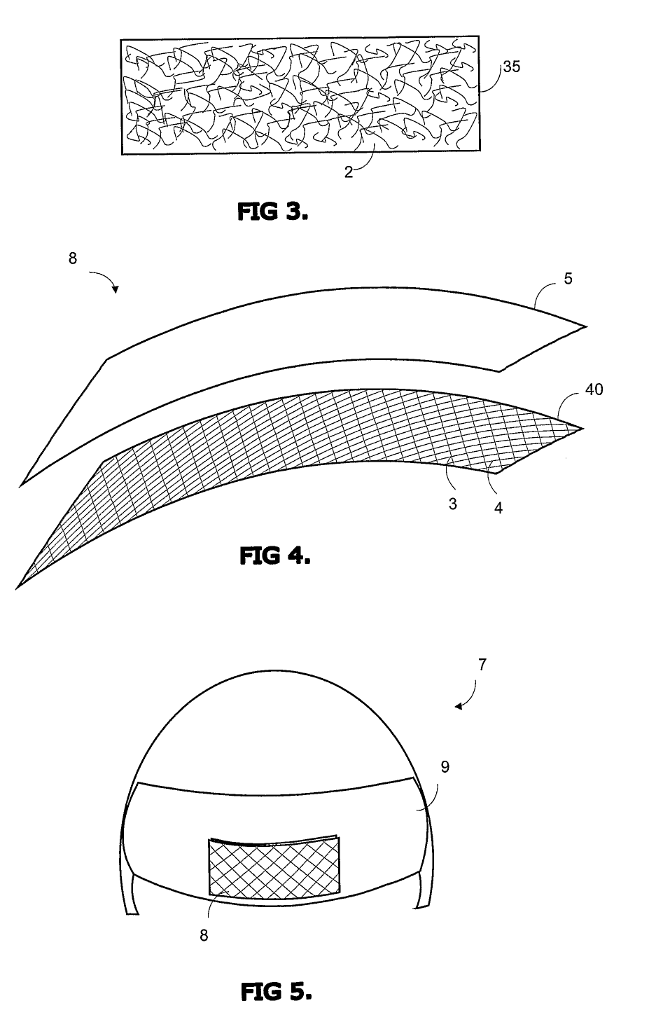

FIG. 3 depicts a cross-sectional view of the flexible substrate according to the invention. An individual glass fiber 2 is shown in a sketchy way inside an exemplary flexible substrate layer 35 according to the invention. This exemplary substrate layer 35 presented can be either before machining or after machining process. Both the thermal and mechanical properties of the glass fiber reinforced plastic substrate depend on orientation of the individual glass fibers 2, as well as dimensions (length, thickness, etc) and shape (round, flat, etc) of the individual fibers 2. For example, if glass fibers 2 having flat shape is used instead of fibers 2 having round shape, denser packing of the glass fibers 2 is obtained and consequently the relative amount of individual glass fibres 2 in the substrate 35 is higher. If longer individual glass fibers 2 are used instead of shorter fibers 2 in the substrate 35, the thermal stability of the substrate 35 will increase. If shorter individual glass fibers 2 are used in the substrate 35, the mechanical durability of the substrate 35 will increase. However, quite a similar flexible substrate can be generated from a high content of short fibers compared to a lower content of long fibers. Also the overlapping of the fibers is a key issue and it correlates to the thickness of the substrate. The thickness of the individual glass fiber 2 is very small, typically equal or less than 0.01 mm, and therefore it would be possible to form very thin substrates 35 with a reasonably even distribution of fibers 2 within the substrate 35. The thickness of the substrate 35 can be 0.1 mm or less. If the shape of individual glass fibers 2 is more flat than round and the thickness of individual glass fibers 2 is small, the substrate 35 contains high relative amount of fibers and if pressed to collapse the substrate 35 has very high density of glass fibers 2.

According to the invention random orientation of the individual glass fibers 2 is provided in the mixture of glass fibres and binding material and consequently in the final substrate 40. The random orientation ensures that the properties are the same along any direction of the substrate material 40. Preferably, an almost homogeneous mixture of glass fibres and binding material, such as plastic or polymer, is formed. Thickness and surface roughness of the substrate 40 according to the invention is controllable. There is also an additional possibility to use a very thin plastic substrate as a carrier, e.g. a plastic film, onto which the glass fibers and binding material is supplied, e.g. sprayed. So the fibers together with the soft binder(s) is arranged to be bound onto a flexible carrier. Together with the carrier film the mixture of the glass fibers and the soft binder form a new slightly thicker substrate with fibers inside in this embodiment.

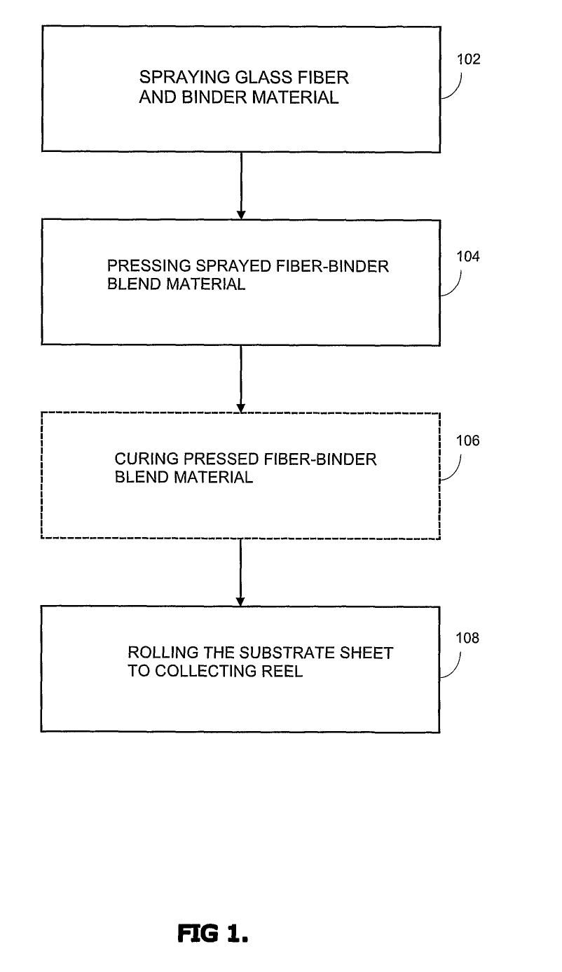

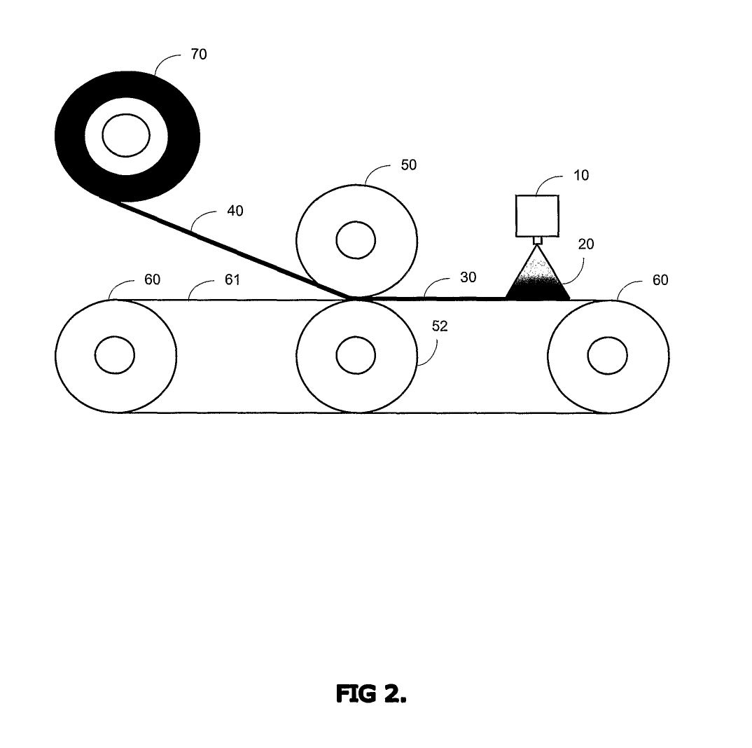

FIG. 1 depicts a block diagram and FIG. 2 a schematic illustration of an embodiment of a method of manufacturing a flexible substrate according to the invention. In the following a spraying process is used as an example of the method to supply glass fibers and binding material together. For example, if extremely good mechanical properties are required, woven glass fibers can be used when supplying fibers and binding material to form a mixture of glass fibers and binding material.

In step 102 there is formed a rough layer of substrate material 30 on the bottom surface 61 by spraying a plurality of glass fibers and binding material 20 to the bottom surface 61. Glass fibers and binding material 20 is sprayed from at least one spray nozzle 10 and the glass fibers (and binder) are sprayed randomly. According to an embodiment of the invention a blend of the glass fibers and the binding material 20 is sprayed from one spray nozzle 10 simultaneously. According to another embodiment of the invention the glass fibers and the binding material are sprayed from same spray nozzle 10 to the bottom surface 61 alternately. According to still another embodiment of the invention the glass fibers and the binding material are sprayed from separate spray nozzles (not shown) to the bottom surface 61. According to a first embodiment in a first stage the binding material is sprayed from a first spray nozzle, then in a second stage the glass fibers are sprayed from a second spray nozzle, and roughlayer of substrate material 30 is formed on the bottom surface 61. Here in the second stage individual glass fibers are injected into the binding material so that they embed inside the binding material. According to a second embodiment in a first stage the binding material is sprayed from a first spray nozzle, in a second stage the glass fibers are sprayed from a second spray nozzle, then in a third stage the binding material is sprayed from a third spray nozzle or from the first spray nozzle again, and finally the roughlayer of substrate material 30 is formed on the bottom surface 61. In the spraying step 102, preferably, the length of the individual glass fibers is relatively short, e.g. order of tens of mm. By spraying short individual fibers in random order to blend together with the polymer binder there is achieved the substrate material having high mechanical durability. The number of spraying stages or the number of spray nozzles is not limited to any number described above.

The step of spraying 102 is implemented as a continuous process or alternatively as a batch process. According to one embodiment of the invention the roughlayer of substrate material 30 is formed on the bottom surface 61 in a form of a continuous substrate material layer 30, i.e. as a sheet of substrate, by means of the moving production line. The production line comprises a conveyor belt type bottom surface 61 which is kept in motion by drive wheels 60. Also the spraying nozzles 10 can be movable above the production line. Another possibility is that the sprayed roughlayer of the substrate material 30 is formed as a batch process which means that process is not continuous. After spraying (a blend of) the glass fibers and the binding material 20 there is formed the roughlayer of substrate material 30 on the bottom surface 61. According still another embodiment of the invention the glass fibers and binding material are arranged to be bound onto a flexible film that is placed on the bottom surface 61.

Then in step 104 of FIG. 1 the sprayed roughlayer of the substrate material 30 proceeds to a pressing stage 50, 52 wherein the substrate material layer 30 is provided with a well controlled thickness and surface roughness. The thickness of the final substrate layer 40 or the sheet of layer is defined in the pressing stage 50, 52. The thickness of the substrate 40 is a very important parameter of the substrate because it determines many essential properties of the behaviour of the substrate material 40, e.g. glass fiber density of the substrate as discussed earlier in this description. In case of continuous process the desired thickness of the substrate sheet 40 can be controlled during the process by changing applied pressure to the sheet 40 in the pressing step 50, 52. In other words, the thickness is arranged to vary along the length of the substrate sheet 40 in such a way that the thickness of the sheet 40 can be changed whenever changing the pressure in the pressing step 50, 52. Consequently, the sheet 40 can be thicker and thinner and thicker again, etc. according to the control of the pressure. The control can be based on certain lengths of the sheet, or certain time periods. Also surface forming of the final substrate layer 40 or layer sheet is controlled accurately in the pressing stage 50, 52. While using continuous process also surface forming can be changed during the process by controlling the pressure in the pressing step. The surface forming can be also changed by changing the roller(s) 50, 52.

FIG. 2 depicts an embodiment of the pressing step 104 in which a continuous process is applied in the spraying and pressing stages. According to one embodiment of the invention, in the pressing step 104, the sprayed roughlayer of the substrate material 30 proceeds to at least one roll 50 which applies pressure to the rough-substrate layer 30 against the bottom surface 61. This applied pressure packs the glass fibers in the substrate material 40 to be closer to each other and defines a desired thickness of the formed substrate material 40. Preferably, instead of one roll 50 a pair of rolls 50, 52 is used and the sprayed roughlayer of the substrate material 30 passes through the pair of rolls 50, 52, and the desired thickness of the substrate material 40 is defined by the space between the rolls 50, 52. The pair of rolls 50, 52 is assembled like batch-off rolls. Naturally the pressing step 104 can also be performed as a simple pressing with a pressing tool in a batch process.

After pressing the roughlayer of substrate material 30 to a desired thickness and surface roughness of the substrate material 40, there is a possibility in this stage—if needed—to cure the substrate material 40 according to step 106 of FIG. 1. Various known curing methods may be used in the production line, such as a heated roll, UV/IR radiation, etc. This step 106 can also be bypassed.

According to still another embodiment of the invention there is provided the step of 108 of FIG. 1, in which the final substrate material 40, e.g. a substrate sheet, is rolled, at the end of the continuous production line, to the collecting reel 70. If the collecting reel is completed with the substrate material, a new collecting reel can be changed to continue to roll the substrate sheet in the production line. By applying at least the steps 102, 104 and 108 depicted in FIG. 1, the manufacturing method can be called as roll-to-roll spray manufacturing of the substrates.

The advantages of the spraying 102 and pressing steps 104 are that the sprayed roughlayer of the substrate material 30 (i.e. glass fiber-binder blend) is pressed in order to obtain the desired thickness of the final substrate material 40, as well as the desired fiber content density of the final substrate material 40 and the desired surface roughness of the final substrate material 40. The method of manufacturing the flexible substrate according to the invention is simple, easy-to-use, low cost and capable of fast volume production.

An alternative approach to use thermoplastic polymers would be to use precursor polymers, or polymerizable solutions of monomers (or similar), that are then crosslinked or polymerized (e.g. by UV or IR) after the spraying step. This would thus not require that the sprayed blend would be heated, and consequently the substrate fabrication process might be done at lower temperatures.

As already mentioned spraying is not the only way to supply the glass fibers and binding material together. However, spraying is preferable to achieve glass fibers to have random orientation in the substrate. Preferably, relatively short individual fibers are optimal for the spraying process. Relatively short fibers have dimensions where individual fibers have length in order of tens of millimetres. Also the percentage of short fibers in the substrate must be selected right in order to have good properties for flexibility. Further in order to ensure flexibility the binding material must be a soft material.

FIG. 4 depicts an exploded view of a flexible display device according to an embodiment of the invention. The flexible display device 8 comprises a layer of the flexible substrate 40 which is equipped with a plurality of transistors 3 and a plurality of conducting lines 4, and a liquid crystal layer 5 facing each other. The plurality of conducting lines 4 is arranged to interconnect the plurality of transistors 3. According to one embodiment of the invention the flexible substrate 40 forms a basis for an active matrix backplane together with the plurality of transistors 3 and the plurality of conducting lines 4 assembled onto the flexible substrate 40. The active matrix backplane which is composed of the substrate 40 with the transistors 3 and conducting lines 4 can be used as a backplane for control electronics e.g. in liquid crystal display devices. The formation of Si transistor structures, e.g. processing of deposited Si thin film and TFT structures, can be optimized onto the flexible substrate 40 according to the invention. As discussed earlier this is achieved due to high thermal stability and mechanical durability of the substrate 40 and this results high suitability for thermal deformation. By attaching the liquid crystal layer 5 to the flexible substrate layer 40 there is provided the flexible display device 8 according to an embodiment of the invention. The attachment can be applied by any known means, e.g. fastening, gluing, adhering, adsorbing, etc. According to an embodiment of the invention the flexible display device 8 comprising the flexible substrate 40 with the transistors 3 and conducting lines 4 and the liquid crystal 5 is manufactured to be in form of an flexible electronic module. The module is provided with connecting means so that the plurality of conducting lines 4 inside the module can be connected outside the module for control, input, output, power supply and other similar known purposes. By these connecting means the module can be connected e.g. to the keyboard, joystick, microphone or other similar user input-output devices.

The flexible display device 8 as well as the flexible electronic module are usable in their various forms ranging from conformable/bendable displays to fully flexible display devices. The flexible display device 8 according to the invention is usable in a variety of portable or non-portable end products, such as computer monitors, portable electronic devices, laptops, personal computers, television sets, PDAs, radio devices, and head up displays (HUD) for implementations in motorcycle helmets, flight helmets or alike, and virtual reality helmets to be used in computer games. This same also applies to the flexible display device in the form of the flexible electronic module.

FIG. 5 depicts an apparatus comprising an embodiment of the flexible display device according to the invention. There is shown, as an example, a helmet 7 equipped with the flexible display device 8 according to the invention which display device 8 is attached or integrated to the helmet 7. In this example the flexible display device 8 is attached to the visor of the helmet 7. The attachment can be applied by any known means, e.g. fastening, gluing, adhering, adsorbing, etc. The flexible display device 8, or alternatively the flexible module, is provided with connecting means so that the plurality of conducting lines 4 inside the module can be connected outside the module for control, input, output, power supply and other similar known purposes. By these connecting means the module can be connected e.g. to the keyboard, joystick, microphone or other similar user input-output devices. Some head up display (HUD) implementations of the helmet 7 are motorcycle helmets, flight helmets or alike, and virtual reality helmets for computer games. Other apparatuses that may comprise the flexible display device 8 according to the invention can be portable or non-portable computer monitors, portable electronic devices, laptops, personal computers, television sets, PDAs, radio devices, etc.

While this invention has been described with reference to illustrative embodiments, this description is not intended to be construed in a limiting sense. Various other embodiments of the invention will be apparent to persons skilled in the art upon reference to this description. It is therefore contemplated that the appended claims will cover any such modifications of the embodiments as fall within the true scope of the invention.

What is claimed is:

1. A flexible substrate for a display, comprising glass fibres and a binding material, wherein said glass fibres are arranged to have random orientation.

2. The substrate of claim 1, comprising a plurality of individual fibres, wherein at least some of the individual fibres overlap each other.

3. The substrate of claim 1, wherein said glass fibres and said binding material form a homogeneous layer.

4. The substrate of claim 1, wherein said binding material comprises a soft thermoplastic polymer material.

5. The substrate of claim 4, wherein the thermoplastic polymer material has a similar refractive index to the glass fibres.

6. The substrate of claim 5, wherein the thermoplastic polymer material is polyester.

7. The substrate of claim 1, wherein said glass fibres and said binding material are bound onto a thin flexible plastic carrier.

8. An electronic device comprising the flexible substrate according to claim 1.

9. A flexible display device comprising a flexible substrate, wherein the flexible substrate comprising glass fibres and a binding material arranged to have said glass fibres in random orientation.

10. The flexible display device according to claim 9 further comprising a plurality of transistors and a plurality of conducting lines configured to form an integrated flexible electronic module with the flexible substrate, wherein the plurality of conducting lines are arranged to interconnect the plurality of transistors within the flexible electronic module.

11. The flexible display device according to claim 10, wherein the flexible electronic module is an active matrix backplane.

12. An electronic device comprising the flexible display device according to claim 9.

13. A helmet comprising the flexible display device according to claim 9.

14. A helmet modified to incorporate the flexible display device of claim 9.

15. A method of producing a flexible substrate for a flexible display device, the method comprising supplying glass fibres and binding material to form a layer wherein glass fibres have random orientation.

16. The method of claim 15, wherein the supplying the glass fibres and binding material occurs simultaneously to form a substrate.

17. The method of claim 15, wherein first supplying the binding material to form a binding material layer and then injecting the glass fibres into the binding material layer.

18. The method of claim 15, wherein a plurality of individual glass fibres are sprayed onto the binding material layer.

19. The method according to claim 15, wherein said glass fibres and said binding material are bound onto a thin flexible plastic carrier.

20. The method of claim 15, further comprising a pressing wherein said substrate is rolled.

21. The method of claim 20, wherein the pressing is variable to provide a non-uniform flexible substrate thickness.

22. The method according to claim 21, wherein said substrate is wound onto a collecting reel.

23. The method of claim 15, wherein the method further comprises curing the layer.

24. The method of claim 15, wherein the binding material comprises soft thermoplastic or precursor polymer material that forms a soft binder upon polymerization and/or chemical modification.

25. The method of claim 15, wherein the binding material comprises soft monomer materials that are crosslinked or polymerized and form a soft binder upon polymerization or crosslinking.

26. A method of producing a flexible display device, wherein the display device comprises the flexible substrate produced according to claim 15.
